(19) United States
(12) Patent Application Publication
(10) Pub. No.: US 2014/0032425 A1
(43) Pub. Date: Jan. 30, 2014

(54) 100% Cycle Guaranteed Product !

(71) Applicant: Mario Marcial Guzman, El reno, OK (US)

(72) Inventor: Mario Marcial Guzman, El reno, OK (US)

(21) Appl. No.: 13/558,487

(22) Filed: Jul. 26, 2012

(51) Int. Cl. G06Q 50/26

(52) U.S. Cl. CPC G06Q 50/26
USPC 705/308

(57) ABSTRACT

What specific groups of people that will help with your idea and who would be the end users?
1. Capital's of the United States of America and Foreign Countries Capital's of the Whole World because it has to be done right, the first time or it's not going to work . . . for many reasons . . . .
2. Who would be the end users? The People

Describe how the idea would be made (if known). Shown on all the New 100% Cycle Guaranteed Product drawing's and note's because it's all new and it creates more Jobs for the Whole World etc. and to be able to live in a better Environment etc. etc. etc.

What need does this invention fulfill? (What problem does your idea solve?)
1. What does this invention fulfill? Good things and a better Environment.
2. What problem does your idea solve? Hopefully everything with Recycling and the other things like for one The Rainforest, The Ozone layer, and pretty much one of the main thing's is Pollution etc. . . . etc. . . . etc.

### BACKGROUND OF THE INVENTION

Are you the original inventor(s)? Yes

Describes the IDEA and what it actually does. How would it be used or operated?
1. Describe the I.D.E.A . . . . It's going to Help the World live in a better Environment
2. What it actually does! It's going to help the Environment!
3. How would it be used or operated! Every day and night, Monday thru Friday 24 hrs, and seven days of the week, month's years and maybe into the next lifetime, and also it's going to create more Jobs for the Whole World, and live in a better Environment.

what features do you believe your IDEA has that makes it unique and appealing? What do you think others will like about your Invention?
1. What features do you believe your IDEA has that makes it unique and appealing?
   It's going to help the Whole World live in a better Environment.
2. What do you think others will like most about your Invention? Everything about it, to the outside and the inside, and how it works on helping the Environment, and it creates more Jobs etc. etc. . . .

### SUMMARY OF THE INVENTION

1 Why did you invent this item? How was your IDEA inspired? Is it job related? I guess job related because it should be done every day.

2. Why did you invent this item? By all the Pollution in the World.

3. How was your idea inspired? . . . . To Help the Environment.

4. Describe the physical characteristics of the IDEA;

a) Size Height_Length_Width_{—}

b) Shape;_{—}

c) Type of materials used: Plastic, Wood, custom made . . . etc. . . . inside and outside homes and etc. . . . etc. . . . Moveable party bin's inside and outside for Wedding's, Bar's Cruise Ships, even for my backyard etc. . . . etc. . . . and Casino's all over the World etc. . . .

Describe possible variations of your IDEA: There is none out There.

are you aware of any competitive product? If yes, give details (I.e. name Price, patent numbers, where found etc.) NO!!

### BRIEF DESCRIPTION OF THE DRAWING

See New 100% Cycle Guaranteed Product!

FIG. 1 FIG. 2 and FIG. 3

See New 100% Cycle Guaranteed Product! FIG. 4

See New 100% Cycle Guaranteed Product! FIG. 5

See New 100% Cycle Guaranteed Product! FIG. 6

See New 100% Cycle Guaranteed Product!

FIG. 7 and FIG. 8

See New 100% Cycle Guaranteed Product! FIG. 9

See New 100% Cycle Guaranteed Product! FIG. 10

See New 100% Cycle Guaranteed Product! FIG. 11

### DETAILED DESCRIPTION

Detailed information and starting to know the rule's and regulation's on the Famous New 100% Cycle Guaranteed Product!, because it is all New. The Famous New 100% Cycle Guaranteed for Dollar's for the Whole World etc., Product, World Wide, T.V., News, Entertainment and etc., etc., and etc., New 100% Cycle Guaranteed Product Truck's and etc., etc., New 100% Cycle Guaranteed Product inside bin's and outside bins New 100% Cycle Guaranteed Product bins and container's, New 100% Cycle Guaranteed Product Containers, New 100% Cycle Guaranteed Product Company, etc., etc., etc., and there all the same New 100% Cycle Guaranteed Product blue print's, New 100% Cycle Guaranteed Product sketch's, New 100% Cycle Guaranteed Product note's, and New 100% Cycle Guaranteed Product drawing's, on the Famous New 100% Cycle Guaranteed for Dollar's etc.

Product Industry World Wide, Planet Earth etc., or even into the next life time etc., and my drawing's and note's on the Famous New 100% Cycle Guaranteed for Dollar's Product etc., show's and explains that the Famous New 100% Cycle Guaranteed for Dollar's bins and containers, are Going to have rules and regulations, and a guide book too.

the two or one extra New 100% Cycle Guaranteed variation bins are going to have rule's and regulation's, and a guide book too, that hold's computer's, cell phones, copper, brass, gold copper, metal's etc., etc.,

And also they are going to unlatch and split, and even where the handle's are on both sides of the New 100% Cycle Guaranteed bin's, and the two or one extra variation New 100% Cycle Guaranteed bin's etc., etc., are going to be able to stick and attach, extra Cycle Guaranteed variation bins, extra New 100% Cycle Guaranteed party bin's and extra New 100% Cycle Guaranteed bins together but, it needs to be talked about on the days to pick-up These item's, or it could be picked-up on the same day, and last but not least, on The Famous Product truck banister's. The Famous New 100% Cycle Guaranteed Banister's and all this needs to be talked about, to make it right the first time, for many reasons.

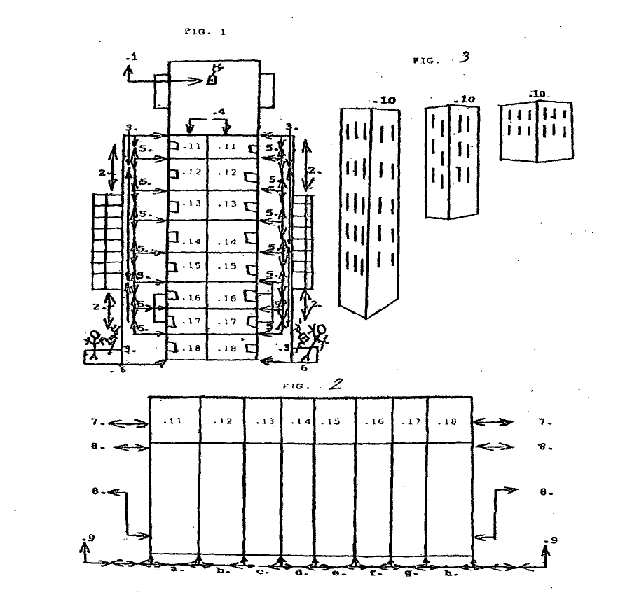

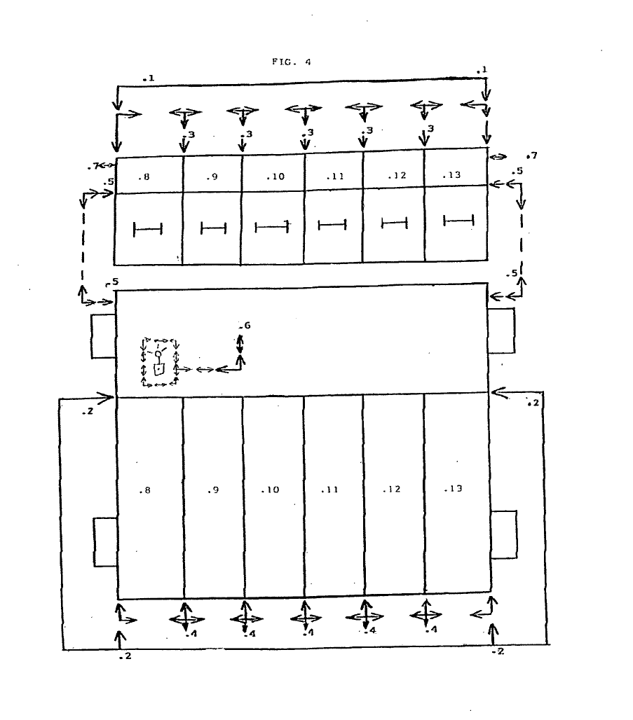

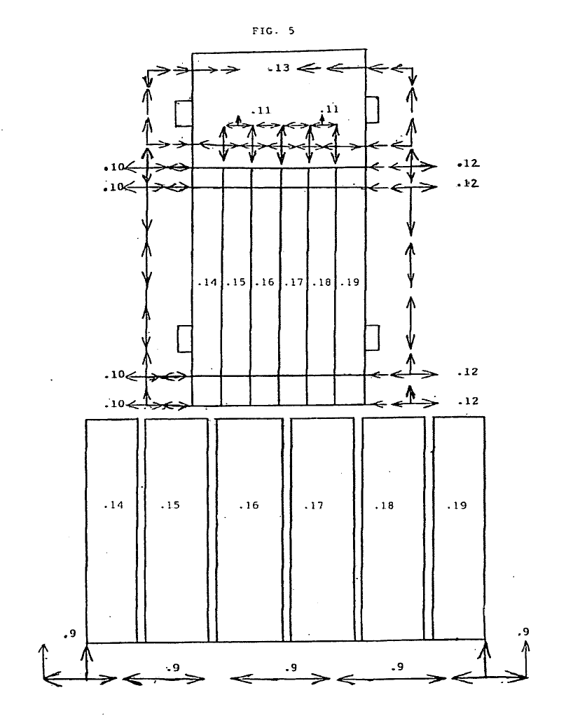

On FIG. 4, FIG. 5 and FIG. 6 should all look like FIG. 1 and FIG. 2 also there is two or One extra New 100% cycle Guaranteed variation bin's, on the Famous New 100% Cycle Guaranteed truck etc., but there could be one extra New 100% Cycle Guaranteed variation bin, instead of two extra New 100% Cycle Guaranteed variation bin's etc. This is why this needs to be talked about, on the Famous New 100% Cycle Guaranteed for Dollars etc. Test Smart Office Factory, to make it right before bringing the Famous New 100% Cycle Guaranteed for Dollar's

Product Industry into the World. Making it right the first time etc., and last but not least. The Great Famous New 100% Cycle Guaranteed party bin's etc., for wedding's, Bar's, Cruise Ships, even for my back yard etc., Casino's, Hollywood, all over the World, etc., Cancun Beach etc., all the Airline Plane's, in the World, all the Train's in the World, because I Know when everything get's said and done there's going to be rule's and regulation's, fines and jail time, and last but not least the

New 100% Cycle Guaranteed for Quadrillion Dollar Industry Company etc., is going to control and store all the Famous Product's etc., safely, and properly and well organized, with a guide book and rule's and regulation's etc., and the White House of the United States of America and Foreign Countries, are going to control all the money to keep everything in order, because this is not a game, this is for the Planet Earth's Environment etc., etc., and it creates more Jobs for the Whole World etc., etc., etc., etc.

See New 100% Cycle Guaranteed Product! FIG. 1 of 1 straight line drawing top view, of the New 100% Cycle Guaranteed Product Truck, and the New 100% Cycle Guaranteed Product container bin's etc., show's and explains and there all the same New 100% Cycle Guaranteed Product Sketch's, $, New 100% Cycle Guaranteed Product note's $, and the New 100% Cycle Guaranteed

Product Drawings, on the Famous New 100% Cycle Guaranteed Product for Dollar's etc., and New Product Industry World Wide, T.V., etc., that everything on the Famous New 100% Cycle Guaranteed for Dollar's Product Truck, is going to be controlled inside the Famous New Truck., with a remote switch to properly, safely control everything, and a camera inside the Famous New Truck, so the Truck Driver etc., can control the Famous New 100% Cycle Guaranteed for Dollar's container bin's etc., that hold and store computer's cell

phones, copper, brass, gold copper, and metal's etc., and there's going to be rule's and regulation's and a guide book, to explain what goes in the Famous New 100% Cycle Guaranteed for Dollar's container bin's etc. While the two workers in the back are properly, safely and well organizing all the Famous New 100% Cycle Guaranteed Product's etc., where they belong, and making sure that everything is safe.

See New 100% Cycle Guaranteed Product! FIG. 1 of 2 arrow straight line drawing top view, on the Famous New 100% Cycle Guaranteed for Dollar's Product Truck and the top view on the New Famous 100% Cycle Guaranteed Product! FIG. 1 on the New 100% Cycle Guaranteed for Dollar's container bin's and the two or one extra New 100% Cycle Guaranteed variation container bin's product etc., and there all the same New 100% Cycle Guaranteed

Product Blue Print's, New 100% Cycle Guaranteed Product sketch's $, New 100% Cycle Guaranteed Product note's and New 100% Cycle Guaranteed Product drawing's, on the New Famous 100% Cycle Guaranteed for Dollar's Product etc., World Wide Industry Company, T.V., etc., show's and explains on the Famous New 100% Cycle Guaranteed for Dollar's container bin's;

that the two or one extra New 100% Cycle Guaranteed variation container bin's, that hold computer's, cell phones, copper, brass, gold copper, metal's etc., and on both of the Famous New 100% Cycle Guaranteed for Dollar's container bin's product's and the two or one extra New 100% Cycle Guaranteed variation container bin's product, are both going to have rule's and regulation's,

and a guide book, to explain what goes in both the Famous New 100% Cycle Guaranteed for Dollar's container bin's product's and the two or one extra New 100% Cycle Guaranteed variation container bin product's etc., and on the New 100% Cycle Guaranteed Product! FIG. 1 of 2 arrow straight line drawing top view, show's and explains that there is going to go side to side, in and out,

up and down, and they're going to rotate circles to properly, safely and well organize and store all the New Famous 100% Cycle Guaranteed for Dollar's Product's and the two or one extra New 100% Cycle Guaranteed variation product's etc., on the New Famous 100% Cycle Guaranteed for Dollar's Truck's and etc.

See new 100% cycle guaranteed product! FIG. 1 of 3 arrow straight line drawing top view, on the famous new product truck's etc., and the new 100% cycle guaranteed for dollar's container bin's product etc., and there all the same new 100% cycle guaranteed product blue print's, new 100% cycle guaranteed product sketch's, new 100% cycle guaranteed product note's, and new 100% cycle guaranteed product drawing's, etc show's and explains that

the famous new 100% cycle guaranteed for dollar's container's bin product, are going to have rule's and regulation's, a guide book too, the two or one extra new 100% cycle guaranteed variation container bin's etc., that hold computer's, cell phones, copper, brass, gold copper, metal's etc., are going to have rule's and regulation's, and guide book also, to explain what goes in the two or one extra new 100% cycle guaranteed variation container's bin etc., show's and explains that FIG. 1 of 3 arrow straight line on the drawing, new 100%

cycle guaranteed product! FIG. 1, show's and explains the famous new 100% cycle guaranteed for dollar's container bin's, and the two or one extra new 100% cycle guaranteed variation container bin's etc., are able to move back and forth, so the two helper's can properly, safely and well organize, store all the new famous product's etc.

See new 100% cycle guaranteed product! FIG. 1 of 4 drawing top view, on the famous new 100% cycle guaranteed truck product etc., and the famous new 100% cycle guaranteed for dollar's container's bin's etc., and the company and there all the same new 100% cycle guaranteed product blue print's, new 100% cycle guaranteed product drawing's, show's and explains

that all the famous new 100% cycle guaranteed container bin's, on all the famous new 100% cycle guaranteed truck's etc. the lid's are going to have one small lid and one whole lid on both sides of the famous new 100% cycle guaranteed bin's on the truck's. no matter what do not weld in the middle from the front to the back of the famous new 100% cycle guaranteed container

bin's, from side to side. It's a whole new 100% cycle guaranteed product container bin's that unlatch and split, one at a time sideway's or take the whole new 100% cycle guaranteed container bin's off sideway's, or straight back off. The famous new 100% cycle guaranteed for dollar's product truck and also, there's going to be pressure crusher plate's, depending on where the new

100% cycle guaranteed crash smart office test, test factory, to make it right the first time for the Whole World, because it's a new 100% cycle guaranteed product etc.

See new 100% cycle guaranteed! FIG. 1 of 5, straight x arrow drawing top view, and there all the same new 100% cycle guaranteed product blue print's, new 100% cycle guaranteed product note's, and new the 100% cycle product drawing's, show's and explains that all the famous new 100% cycle guaranteed for dollar's etc., are going to have rule's and regulation's and a guide

book too. The two or one extra new 100% cycle guaranteed variation container bin's, that hold computer's cell phones, copper, metal's etc., and they are also going to have rule's and regulation's and a guide book, to explain what goes in the two or one extra new 100% cycle guaranteed variation container bin's etc., show's and explains, that they're going to be able to unlatch

and split, and take off one at a time, or stick and attach extra one's where the handle's and wheel's are, to stick extra new 100% cycle guaranteed container's and bin's together if needed, or take the whole thing off, to properly, safely and well organize, store or repair the famous new 100% cycle guaranteed for dollar's company product's etc., worldwide.

See new 100% cycle guaranteed product! FIG. 1 of 6, drawing top view, on the famous new 100% cycle guaranteed for dollar's truck product, and the famous new 100% cycle guaranteed for dollar's container bin's, and there all the same new 100% cycle guaranteed product blue print's, new 100% cycle guaranteed product's sketch's, new 100% cycle guaranteed product note's, and new 100% cycle guaranteed product drawing's show's and explains that the two

helper's on both sides in the back are to control everything with a remote on the famous new 100% cycle guaranteed for dollar's container bin's etc., and also, there going to have rule's and regulation's, and a guide book too, and the two or one extra new 100% cycle guaranteed variation container bin's, that hold computer's, cell phones, copper, brass, gold copper, metal's etc., and they are going to have rule's and regulation's and a guide book, to explain on what goes in the two or one extra new 100% cycle guaranteed variation container bin's etc., while the driver is taking a five or ten minute break to properly, safely keep the helper's working etc.

See new 100% cycle guaranteed product! FIG. 2 of 0.7 straight arrow drawing side view, etc., and the famous new 100% cycle guaranteed for dollar's product etc., industry World Wide, T.V., etc., and there all the same new 100% cycle guaranteed product blue print's, new 100% cycle guaranteed product sketch's, new 100% cycle guaranteed product note's, and new 100% cycle guaranteed product drawing's, on the famous new 100% cycle guaranteed for dollar's, famous company product's etc, show's and explains that the famous new 100% cycle guaranteed for dollar's container bin's, are going to have rule's

and regulation's, and a guide book too. The two or one extra new 100% cycle guaranteed variation container bin's, that hold computer's, cell phones, copper, brass, gold copper, metal's etc., and they are also, going to have rule's and regulation's and a guide book, to explain what goes in the two or one extra new 100% cycle guaranteed variation container bin's etc., show's and explains that the lid's are going to slide in and out, up and down, and have a smaller hole on either side or top, to safely store all the famous company product's etc.

See new 100% cycle guaranteed product! FIG. 2 of 0.8 crooked straight arrow drawing side view, of the famous new 100% cycle guaranteed for dollar's container bin's and the two or one extra new 100% cycle guaranteed variation container bin's and the famous new 100% cycle guaranteed for dollar's etc., product industry World Wide, T.V., etc and there all the same new 100% cycle guaranteed product blue print's, new 100% cycle guaranteed product sketch's, new 100% cycle guaranteed product note's, and new 100% cycle guaranteed product drawing's, on the famous new 100% cycle guaranteed for dollar's product industry etc., show's and explains that the famous new 100% cycle guaranteed for dollar's container bin's are going to have rule's and regulation's, and a guide book too, and the two or one extra new 100% cycle guaranteed variation container bin's, that hold computer's, cell phones, copper, brass, gold copper, metal's etc., and there's going to be rule's and regulation's,

and guide book, to explain what goes in the two or one extra new 100% cycle guaranteed variation container bin's etc., show's and explains on the new 100% cycle guaranteed product! FIG. 2 of 0.8 crooked straight arrow drawing side view, of the famous new 100% cycle guaranteed container bin's, and the two or one extra new 100% cycle guaranteed variation container bin's, and the new 100% cycle guaranteed party container bin's etc., are going to have handle's and wheel's on both sides on every new 100% cycle guaranteed container bin's,

on every two or one extra new 100% cycle guaranteed variation container bin's etc., and last but not least the new 100% cycle guaranteed party container bin's etc., and they're going to be able to add on both sides, where the handle's and wheel's are on the two or one extra new 100% cycle guaranteed variation container bin's, the new 100% cycle guaranteed for dollar's container bin's and extra famous new 100% cycle guaranteed container bin's etc., World Wide product's.

See new 100% cycle guaranteed product! FIG. 2 of 0.9 straight arrow x drawing side view, of the famous new 100% cycle guaranteed for dollar's container bin's, and the two or one extra new 100% cycle guaranteed variation container bin's and the famous new 100% cycle guaranteed for dollar's etc., product industry World Wide, T.V., etc., and there all the same new 100% cycle guaranteed product blue print's, new 100% cycle guaranteed product sketch's,

new 100% cycle guaranteed product note's, and new 100% cycle guaranteed product drawing's on the famous new 100% cycle guaranteed for dollar's product etc., show's and explains, that the famous new 100% cycle guaranteed for dollar's container bin's etc., are going to have rule's and regulation's, and a guide book too. The two or one extra new 100% cycle guaranteed variation container bin's etc., that hold computer's, cell phones, copper, brass, gold copper, metal's etc., and they're going to also have rule's and

regulation's, and a guide book, to explain what goes in the two or one extra new 100% cycle guaranteed variation container bin's etc., show's and explains what the new 100% cycle guaranteed product! FIG. 2 of 0.9 straight arrow x drawing side view, of the famous new 100% cycle guaranteed for dollar's container bin's etc., and the two or one extra new 100% cycle guaranteed variation container bin's etc., that they are going to unlatch and spilt, and even

where the handle's are on both sides, on every famous new 100% cycle guaranteed product for dollar's container bin's, and the two or one extra new 100% cycle guaranteed product variation container bin's, and the new 100% cycle guaranteed product party container bin's, are going to be able to stick and attach extra new 100% cycle guaranteed product container bin's, extra two or one new 100% cycle guaranteed product variation bin's, and extra new 100% cycle guaranteed product party container bin's, etc., together.

See new 100% cycle guaranteed product! FIG. 3 of 0.10 show's and explains the famous new 100% cycle guaranteed for dollar's etc., Quadrillion dollar's industry company product etc., and there all the same new 100% cycle guaranteed product blue print's, new 100% cycle guaranteed product sketch's, new 100% cycle guaranteed product note's, and new 100% cycle guaranteed product drawing's, on the new 100% cycle guaranteed product! FIG. 3 of 0.10 show's and explains that the famous new 100% cycle guaranteed for dollar's, Quadrillion dollar's industry company etc., is going to control and store all the famous product's etc properly, safely and well organize with the rule's and regulation's, and a guide book, to explain on how to properly, safely and well organize, cycle all the famous company product's etc., and the White House of the United States of America, and Foreign countries are going to control all the money to keep everything in order etc., because this is not a game, this is for the

Planet Earth's environment etc., etc and there's going to be skyscraper's one in every state within the fifty states and the foreign county's that have business office's that log in and control and talk only to other famous company business office people to handle and control the new 100% cycle guaranteed product cycle because it's all new and this new 100% cycle guaranteed product creates thousand etc of new jobs for the whole world etc for the environment.

See new 100% cycle guaranteed product! FIG. 1 and FIG. 2 of 0.11 illustrates cardboard only goes into this container etc., 0.12 illustrates paper only goes into this container etc., 0.13 illustrates plastic only goes into this container etc., 0.14 illustrates bottle's only goes into this container etc., 0.15 illustrates can's only goes into this container etc., 0.16 illustrates can food's only goes into this container etc., 0.17 and 0.18 illustrates that this new 100% cycle guaranteed product for the whole world is going to have two or one extra variation container to hold computer's, cell phones, copper, brass, gold copper, metal's, etc., inside container bin's and outside container bin's etc., costumed inside container bin's and costumed outside container bin's

See new 100% cycle guaranteed product! FIG. 4 and of 0.1 straight line arrow drawing, show's and explains to leave the whole new 100% cycle guaranteed for dollar's banister's on and together when easily, safely, cleanly and well organize, when lifting and rotating, and properly storing all of the famous company product's ect, into the new famous 100% cycle guaranteed for dollar's banister's and into the back of the new 100% cycle guaranteed for dollar's truck ect. The same thing when carefully and safely placing the new famous 100% cycle guaranteed for dollar's banisters back down where it is supposed to place at. It belongs on earth to preserve the planet earth ect., for all the day's, night's, month's, year's, holiday's, 24-seven, seven day's out of the week, and last but not least Christmas every year, all the gift wrapping is going to be new 100% cycled guaranteed!

See new 100% cycle guaranteed product! FIG. 4 of 0.2 straight line arrow drawing at the bottom of 0.2 straight line arrow drawing explains and show's, that the famous new 100% cycle guaranteed for dollar's truck, new 100% cycle guaranteed container's can come off or on all at once to easily, safely, cleanly and well organize and properly store, the whole banister's and transport all of the famous product's ect., with the rule's and regulation's if not, I know when everything get's said and done there's going to be fines and jail time.

See new 100% cycle guaranteed product! FIG. 4 of 0.3 arrow dash drawing, show's and explains that the new famous 100% cycle guaranteed for dollar's product banister's ect., is going to be able to unlatch and split one at a time, to take off and put back on and the two or one extra new 100% cycle variation container bin's on both sides of the new 100% cycle guaranteed banister's, where the handle's are to add two or one more extra new 100% cycle guaranteed variation bin's if needed to easily, safely, cleanly and well organize and properly store all the famous product's ect., with the rule's and regulation's if not, I know when everything get's said and done there's going to be fines and jail time.

See new 100% cycle guaranteed product! FIG. 4 of 0.4 arrow dash drawing at the bottom, show's and explains the famous new 100% cycle guaranteed for dollar's company truck and etc., new 100% cycle guaranteed container's banister's are also going to be able to unlatch and split, to take off and put on one at a time, to stick two or one extra variation new 100% cycle guaranteed container bin's, to easily and safely, cleanly and well organize, and properly store all the famous product's etc., with the rule's and regulation's, if not I know when everything get's said and done there's going to be fines and jail time etc.

See new 100% cycle guaranteed product! FIG. 4 of 0.5 line dash arrow drawing, show's and explains option fork's or a bar rotator to lift and rotate the famous new 100% cycle guaranteed for dollar's banister's and company product's into the famous new 100% cycle guaranteed for dollar's banister's truck, and also to make sure all my drawing's and note's are going in the same new 100% cycle guaranteed ect., and no matter which way you place it or put it, and anywhere in the world, this great famous new 100% cycle guaranteed ect. For dollar's product for the whole world will always go in the same new 100% cycle guaranteed ECT.

See new 100% guaranteed product! FIG. 4 of 0.6 line dash arrow drawing, show's and explains on the new 100% cycle guaranteed for dollar's ect., that everything on all the truck's ect., is going to be properly controlled inside the new 100% cycle guaranteed for dollar's truck ect. For example on FIG. 4 of 0.6 the remote inside the new 100% cycle guaranteed for dollar's truck etc., will have a switchboard, button's, truck dash button's, to easily and safely control and store all the famous product's safely and neatly etc., on the new 100% cycle guaranteed product banister's etc.

See new 100% guaranteed product! FIG. 4 of 0.7 straight line arrow drawing, on the new 100% cycle guaranteed product banister's ect, The lid's are going to have one small hole and one big hole to properly load and unload, and store the famous new 100% cycle guaranteed product's and also, the lid's are going to open one at a time to unload and load with the control's inside the famous new 100% cycle guaranteed truck banister's. the truck banister's are going to do the same thing open and close, with the control's inside the famous new 100% cycle guaranteed truck banister's etc., and with a camera inside and outside to safely control and store all the famous product's safely etc., and there's going to be pressure crusher plate's depending on where the new 100% cycle guaranteed crash smart office test factory, to make it right the first time for the whole world, because it's a new 100% cycle guaranteed product etc., for the whole world and this new company cerate's more job's etc.

See new 100% guaranteed product! FIG. 4 of 0.8 illustrates cardboard only goes into this container etc., 0.9 illustrates paper only goes into this container etc., 0.10 illustrates plastic only goes into this container etc., 0.11 illustrates bottle's only goes into this container etc., 0.12 illustrates can's only goes into this container etc., 0.13 illustrates can food's only goes into this container etc, and FIG. 4 is also going to have a new 100% cycle guaranteed two or one extra variation container to hold computer's, cell phones, copper, brass, gold copper, metal's, etc., inside container bin's and outside container bin's etc., custom ad inside container bin's and custom made outside container bin's etc.

See new 100% cycle guaranteed! FIG. 5 of 0.9 straight arrow dash yard factory, and the factory is going to have surveillance ect., and moveable assembly line show's and explains the famous new 100% cycle guaranteed for dollar's container's bin's can easily, safely, cleanly and well organize, and properly move side to side to unload and store the famous product's ect., to safely help the famous new 100% cycle guaranteed for dollar's truck, without having to back the famous new 100% cycle guaranteed for dollar's truck, and the assembly line is going to have a remote to hook up to the new 100% cycle guaranteed container bin's product to easily, cleanly and well organize all the famous product's ect.

See new 100% cycle guaranteed product! FIG. 5 of 0.10 straight line x arrow's drawing, show's and explains that the famous new 100% cycle guaranteed for dollar's can take the pressure crusher plat's machine off and on. The famous new 100% cycle guaranteed for dollar's container's bin's off and on, and the new two or one extra 100% cycle guaranteed variation container bin's on at the same time for repair's or properly, safely store the new 100% cycle guaranteed container bin's and the new two or one extra 100% cycle guaranteed variation container bin's and pressure crusher plate's and be able to safely raise the famous new 100% cycle guaranteed or dollar's etc., bin's up and down, or to push out and in, to properly store the famous company product's, if not, I know when everything get's said and done there's going to be fines and jail time etc.

See new 100% cycle guaranteed product! FIG. 5 of 0.11 dash arrow's drawing, show's and explains the new two or one extra new 100% cycle guaranteed variation container bin's, famous new 100% cycle guaranteed for dollar's bin's can safely spilt, and unlatch to be able to take off one at a time, or put on one at a time, or put a new one on, and take the old one off for repair's and safely store the container and the new two or one extra 100% cycle guaranteed variation container bin's the famous new 100% cycle guaranteed for dollar's bin's and product's and the famous new 100% cycle guaranteed for dollar's container's bin's ect., are going to rule's and regulation's and a guide book too. The new two or one extra 100% cycle guaranteed variation container bin's that hold computer's, cell phones, copper, brass, gold copper, metal's ect., and there is going to be rule's and regulation's and a guide book also, to explain what goes in the two or one extra new 100% cycle guaranteed variation container bin's and they're going to unlatch and split, and even where the handle's are on both sides of the new 100% cycle guaranteed bin's and the two or one extra new 100% cycle guaranteed variation container bin's are going to be able to stick and attach extra new 100% cycle guaranteed bin's and extra party bin's ect., together.

See new 100% cycle guaranteed product! FIG. 5 of 0.12 dash arrow's drawing, show's and explains the famous new 100% cycle guaranteed for dollar's container bin's and the two or one extra cycle variation container bin's etc., and the pressure crusher's plate's on both side's the truck, can come off one at a time, and put back on one at a time to safely repair, and put a new one on or take and safely store all the new famous 100% cycle guaranteed for dollar's pressure crusher plate's. New 100% cycle guaranteed container bins, and the new two or one extra 100% cycle guaranteed variation container bin's product's ECT. Safely and neatly.

See new 100% cycle guaranteed product! FIG. 5 of 0.13 dash arrow drawing, show's and explains that all the famous new 100% cycle guaranteed for dollar's truck's, container bin's and pressure crusher plate's, and the two or one extra new 100% cycle guaranteed for dollar's truck's, container bin's and pressure crusher plate's, and the two or one extra new 100% cycle guaranteed variation container bin's are going to go up down with the control's inside the truck ect., and a camera inside and outside to safely, properly control and store everything neatly and safely ect.

See new 100% cycle guaranteed product! FIG. 5 of 0.14 illustrates cardboard only goes into this container ECT. 0.15 illustrates paper only goes into this container ect., 0.16 illustrates plastic only goes into this container etc., 0.17 illustrates bottle's only goes into this container etc., 0.18 illustrates can's only goes into this container etc., 0.19 illustrates can food's only goes into this container etc and FIG. 5 is also going to have a new 100% cycle guaranteed two or one extra variation container to hold computer's, cell phones, copper, brass, gold copper, metal's, etc., inside container bin's and outside container bin's etc., costumed inside container bin's and costumed outside container bin's etc.

See new 100% cycle guaranteed product! FIG. 6 of 0.14 dash arrow drawing top view, show's and explains on the left side, that everything on the famous new 100% cycle guaranteed for dollar's container bin's truck ect., is going to be controlled by a remote, or a control panel, inside the truck to properly, safely and well organize, and store all the famous product's ect., and camera inside and outside to safely control and store all the famous product's safely and neatly ect.

See new 100% cycle guaranteed product! FIG. 6 of 0.15 straight line x arrow drawing top view, on the left side, show's and explains that the famous new 100% cycle guaranteed for dollar's container's bin's, and the two or one extra new 100% cycle guaranteed container bin's ect., truck ect., is going to be able to take off the whole new 100% cycle guaranteed for dollar's container, and the two or one extra new 100% cycle guaranteed variation container bin's ect., off all at once for repair's and store the famous new 100% cycle guaranteed container bin's, and the two or one extra variation container bin's ect., and product's ect., to place the famous new 100% cycle guaranteed for dollar's bin's container, and the two or one extra new 100% cycle guaranteed variation container back on to the famous new 100% cycle guaranteed dollar's truck ect., properly and safely.

See new 100% cycle guaranteed product! FIG. 6 of 0.16 straight X arrow line drawing top view, on the left side, show's and explains all the front and back sides of the pressure crusher plate's are going to be able to take off all at once for repair's and properly store the famous pressure crusher plate's and be able to put back on safely and properly ect.

See new 100% cycle guaranteed product! FIG. 6 of 0.15 and 0.16 straight line x arrow drawing top view, show's and explains on the left side on both, the famous new 100% cycle guaranteed for dollar's container bin's, and the two or one extra new 100% cycle guaranteed variation container bin's, that's on the famous new 100% cycle guaranteed for dollar's truck ect., and the pressure crusher plate's are going to be able to be taken off all together to store properly, and for repair's ect., and to be able to be put back on all together to safely, properly, well organize the famous new 100% cycle guaranteed container bin's ect., and the new two or one extra new 100% cycle guaranteed variation container's bin's ect., and pressure crusher plate's ect.

See new 100% cycle guaranteed product! FIG. 6 of 0.17 arrow dash drawing top view, show's explains on the right side, that the pressure crusher plate's are going to be able to be taken off, one at a time for repair's, and to store, properly, safely, and well organize, also the famous pressure crusher plate's will be able to be put back on one at a time properly and safely ect.

See new 100% cycle guaranteed product! FIG. 6 of 0.18 arrow dash drawing top view, show's and explains on the right side, that the famous new 100% cycle guaranteed for dollar's container's bin's ect., are going to be able to be taken off, one at a time for repair's, or store the famous new 100% cycle guaranteed for dollar's container bin's ect., properly, safely and well organize ect., and also the famous new 100% cycle guaranteed for dollar's container bin's ect., properly, safely and well organize ect., and also the famous new 100% cycle guaranteed for dollar's container bin's are going to be able to be put back on, one at a time, properly, and safely ect., and the new two or one extra new 100% cycle guaranteed variation container bin's ect.

See new 100% cycle guaranteed product! FIG. 6 of 0.17 and 0.18 arrow dash drawing top view, on the right side show's and explains that both the famous new 100% cycle guaranteed for dollar's container bin's etc., and the two or one extra new 100% cycle guaranteed variation container bin's etc., and the famous pressure crusher front and back plate's are going to both be able to taken off too, together, one both at the same time, for repair's or to store them properly, safely, and well organize etc., and also the famous new 100% cycle guaranteed for dollar's container bin's and pressure crusher plate's are going to be put back on properly, safely and they're going to add two or one extra new 100% cycle guaranteed variation bin's that have a guide book, and rule's and regulation's too, that hold's computer's, cell phones, copper, brass, gold copper, metal's etc, and the two extra new 100% cycle guaranteed bin's and party, new 100% cycle guaranteed bin's etc., are going to have handle's and wheel's on both sides on every new 100% cycle guaranteed bin's, extra new 100% cycle guaranteed variation bin's and party new 100% cycle guaranteed bin's etc., they're going to be able to add on both sides where the handle's and wheel's are extra variation new 100% cycle guaranteed bin's, extra party new 100% cycle guaranteed bin's, extra new 100% cycle guaranteed bin's, extra famous 100% cycle guaranteed bin's product etc., See new 100% cycle guaranteed product! FIG. 6 of 0.19 arrow dash top view, show's and explains in the truck that the whole new 100% cycle guaranteed for dollar's container bin's etc., and the new two or one extra new 100% cycle guaranteed variation container bin's etc., and the famous pressure crusher plate's together are going to go up and down, to properly, safely and well organize and store all the famous product's and they're going to be controlled inside the truck etc., on the famous new 100% cycle guaranteed for dollar's etc., product industry worldwide, and with a camera

inside and outside to safely control and store all the famous product's safely and neatly etc.

See new 100% cycle guaranteed product! FIG. 6 of 0.20 illustrates cardboard only goes into this container etc., 0.21 illustrates paper only goes into this container etc., 22 illustrates plastic only goes into this container etc., 23 illustrates bottle's only goes into this container etc., 24 illustrates can's only goes into this container etc., 25 illustrates can food's only goes into this container etc., and FIG. 6 is also going to have a new 100% cycle guaranteed two or one extra variation container to hold computer's, cell phones, copper, brass, gold copper, metal's, etc., inside container bin's and outside container bins etc., costumed inside container bin's and costumed outside container bin's etc.

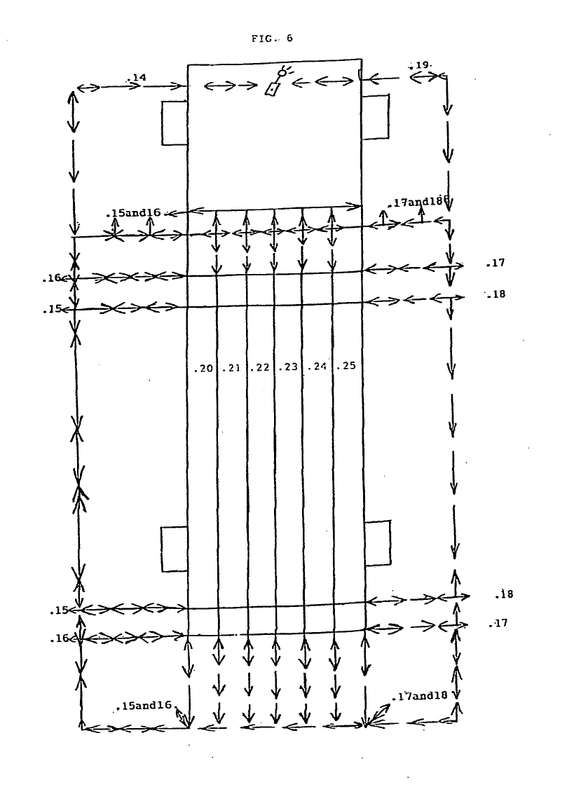

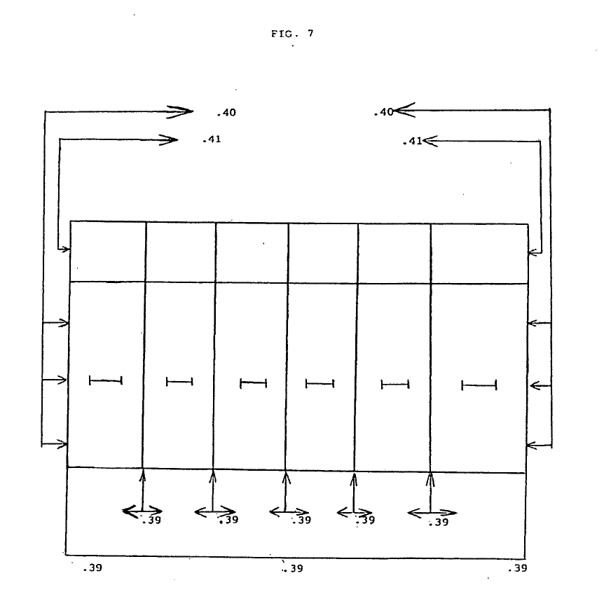

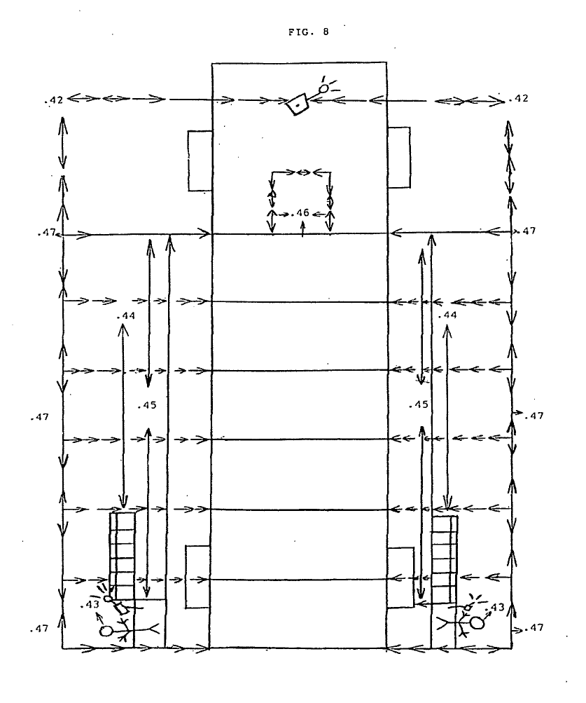

See new 100% cycle guaranteed product! FIG. 7 of 0.39 arrow dash drawing side view, show's and explains there all the same blue print's, sketch's, note's and drawing's on the famous new 100% cycle guaranteed extra variation bin's. This is the same, but will be picked up on a different day of the week, or the same day. Arrow dash drawing of 0.39 show's and explains the extra new 100% cycle guaranteed variation bin's are going to do the same thing, unlatch and split, and hold together to properly, safely and well organize all the famous product's etc, with the rule's and regulation's and if not, I know when everything get's said and done there's going to be jail time and fine's.

See new 100% guaranteed product! FIG. 7 of 0.40 arrow dash drawing side view, show's and explains that the extra new 100% cycle guaranteed variation container bin's are the same bin's but, will be picked up on a different day of the week, or the same day, show and explains that the extra new 100% cycle guaranteed bin's etc, is going to have handle's and wheel's etc., to properly, safely and well organize all the famous product's etc.

See new 100% cycle guaranteed product! FIG. 7 of 0.41 a Drawing side view, show's and explains there all the same blue print's, sketch's, Notes and drawing's on this extra new 100% cycle guaranteed variation bins.

The lids are going to be able to slide in and out, open up and down, and have a smaller opening to not have to open the whole lid etc., and between, they're going to have some kind of teeth, so when you go to rotate the bin's, to be able to store the famous product's etc. The lid's and the truck lid's are going to have teeth to open the new 100% cycle guaranteed bin's with a push of a button, inside the truck and next to the two helper's in the back, and also there's going to be pressure crusher plate's depending on where the new 0.100% cycle guaranteed crash smart office test factory to make it right the first time, for the whole world, because it's a new 100% cycle guaranteed product etc.

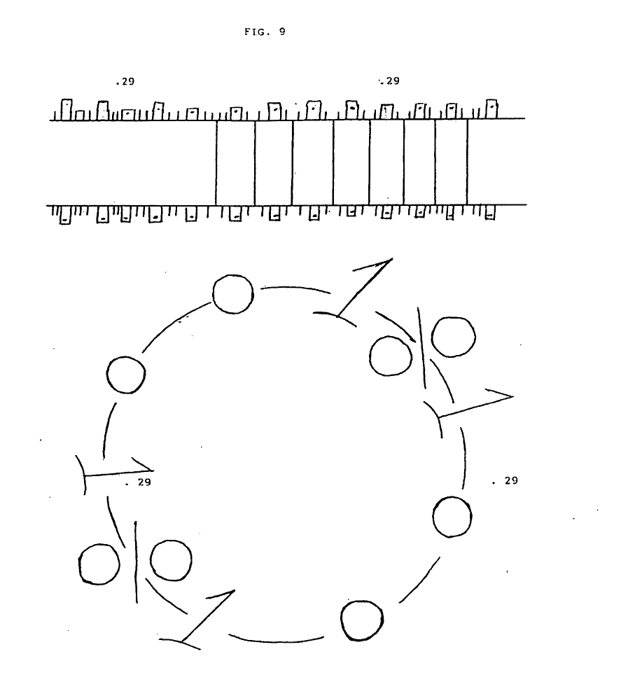

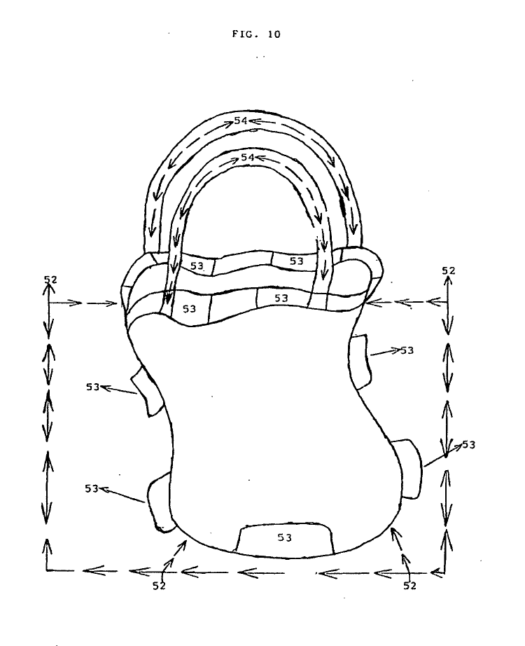

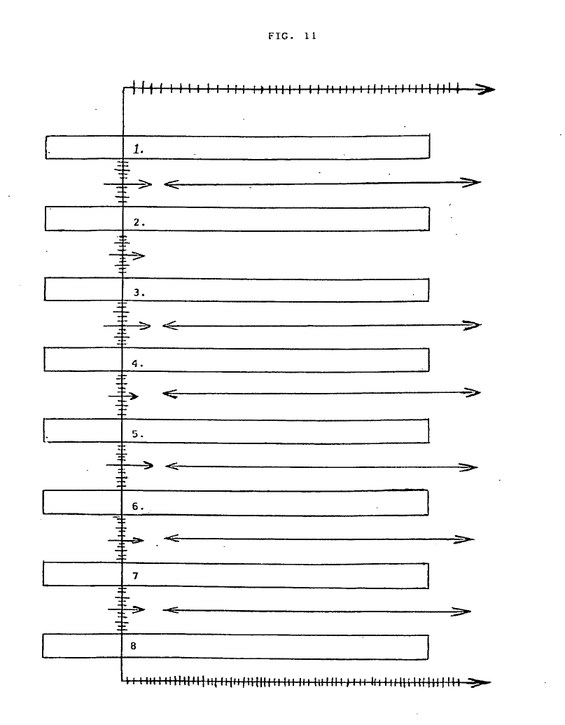

See new 100% cycle guaranteed product! FIG. 8 of 0.42 straight arrow drawing top view, show's and explains there all the same blue print's, sketch's, note's, and drawing's on the new 100% cycle guaranteed for dollar's product etc., and this is a extra new 100% cycle guaranteed variation bin truck, but the same truck is going to be controlled inside the truck etc., with a remote Switch to properly, safely, control everything, and a camera inside the truck ECT. So the truck driver can control the famous new 100% cycle guaranteed extra

variation container bin's, and truck, with the rule's and regulation's etc., while the two helper's in the back are properly, safely, and well organizing the extra new 100% cycle guaranteed variation product, back where they belong, and making sure that everything is safe.

See new 100% cycle guaranteed product! FIG. 8 of 0.43 drawing top view, show's and explains there all the same blue print's, sketch's, note's, and drawing's on the extra famous new 100% cycle guaranteed variation container bin's, that the two helper's on both sides in the back, are going to control everything with a remote on the famous new 100% cycle guaranteed variation container bin's, while the driver etc., is taking a five or ten minute break, to properly, safely, keep the helper's working etc.

See new 100% cycle guaranteed product! FIG. 8 of 0.44 drawing straight arrow top view, show's and explains that the extra new 100% cycle guaranteed variation bin's are going to go side to side, in and out, and up and down, and they're going to rotate in circles, to properly, safely, and well organize And store all the famous product's ECT. On both sides of the famous new 100% Cycle guaranteed for dollar's truck ECT. With the rules and regulations and this new company industry for the whole world creates a lot of new jobs as one company only.

See new 100% cycle guaranteed product! FIG. 8 of 0.45 straight arrow drawing top view, show's and explains on both sides of the famous new 100% cycle guaranteed extra variation container bin's, and there all the same blue print's, sketch's, note's, and drawing's on the extra new 100% cycle guaranteed variation product, industry worldwide, that on both sides of the famous new 100% cycle guaranteed variation container bin's, show's and explains that the straight arrow line's show the extra new 100% cycle guaranteed variation container bin's being able to move back and forth so the two helper's can properly, safely, and well organize and store all the extra new 100% cycle guaranteed variation famous product's etc.

See new 100% cycle guaranteed product! FIG. 8 of 0.46 arrow dash drawing, show's and explains the lid's are going to be able to slide and Open up and down, and have a smaller opening to not have to open the whole Lid ECT. And between, they're going to have some kind of teeth, so when you go To rotate the bin's, to be able to store the famous product's ECT. The lid's and

truck lid's are going to have teeth to open the new 100% cycle guaranteed bin's with a push of a button inside the truck, the truck, and next to the two helper's in the back, and also there's going to be pressure crusher plate's depending on where the new 100% cycle guaranteed crash smart office test, test factory to make it right, the first time for the whole world, because it's a new 100% cycle guaranteed product etc.

See new 100% cycle guaranteed product! FIG. 8 of 0.47 arrow dash drawing top view, show's and explains that all the extra new 100% cycle guaranteed variation container bin's, are going to be able to unlatch and split, or take the whole thing off, and to switch the famous new 100% cycle guaranteed for dollar's container bin's over, to be able to pick up the extra new 100% cycle guaranteed variation bin's on a different day, or the same day, or you could get extra new 100% cycle guaranteed variation truck, so you won't have to switch the famous new 100% cycle guaranteed for dollar's container bin's to the extra New 100% cycle guaranteed variation container bin's ECT. To properly, safely and well organize and store or repair the extra new 100% cycle guaranteed variation.

container bin's and there all the same blue print's, sketch's, note's and drawing's on both the famous new 100% cycle guaranteed for dollar's container bin's act., product and the extra new 100% cycle guaranteed variation container bin's and truck product's industry worldwide etc.

See new 100% cycle guaranteed product! FIG. 9 of 0.29 show's and explains there going to be new 100% cycle guaranteed for dollar's etc., train's worldwide to safely, properly, store and transport all the famous product's and they're the same blue print's, sketch's, note's and drawing's on the famous new 100% cycle guaranteed for dollar's etc., product industry worldwide.

See new 100% cycle guaranteed product! FIG. 10 of 0.52 zipper's straight arrow drawing side view, show's and explains that this is going to be the new texture plastic ect., for the famous new 100% cycle guaranteed for dollar's product bin's ect., different sizes and color's too, and different kinds of cloth's and plastic texture and picture's ect., and also there's going to be zipper or something similar to the zipper on every side to properly clean out, and reuse, and to safely store the famous product's into the famous new 100% cycle guaranteed for dollar's container bin's and extra new 100% cycle guaranteed variation container bin's and the party new 100% cycle guaranteed container bin's ect.

See new 100% cycle guaranteed product! FIG. 10 of 0.53 arrow handle's drawing side view, show's and explains that there's going to be a handle everywhere to easily, safely store the famous product's ect.

See new 100% cycle guaranteed product! FIG. 10 of 0.54 handle drawing side view, show's and explains that there's going to be a top handle and they're going to push in and out to store the handles when not being used ECT.

See new 100% cycle guaranteed product! FIG. 11 of 1. 2. 3. 4. 5. 6. 7. 8. Show's and explains the global money graph throw the chart never fall quadrillion dollar's the white house and the foreign countries and the inventor will receive never fall 1. Untied states of America ECT, money graph money ECT. Money graph money ECT, never fall 2. Foreign country's ECT, quadrillion dollar's ECT the white house and foreign country will receive never fall 3. Church's of

Jesus ECT, money graph money ECT, money graph money ECT, never fall 4. Washington ECT, quadrillion dollar's ECT the white house and foreign country will receive never fall 5. Washington. D.C. ECT money graph money ECT, money graph money ECT, never fall 6. Untied states of America ECT, quadrillion dollar's ECT, the white house and foreign country will receive ECT, never fall 7. China, France, Sweden ECT, money graph money ECT, money graph money ECT, never fall 8. Mexico, Texas, Russian, ECT.

I claim:

1. General information and starting to know the rules and regulations on the famous new 100% cycle guaranteed product! Because it is all new. The famous new 100% cycle guaranteed for dollar's for the whole world etc., product, World Wide, T.V., news, entertainment and etc., and etc., new 100% cycle guaranteed product truck's and etc., new 100% cycle guaranteed product inside bin's and outside bin's etc., new 100% cycle guaranteed product bin's and container's, new 100% cycle guaranteed product container's, new 100% cycleguaranteed product company, etc., etc., etc., and there all the same new 100% cycle guaranteed product blue print's, new 100% cycle guaranteed product sketch's, new 100% cycle guaranteed product note's, and new 100% cycle guaranteed product drawing's, on the famous new 100% cycle guaranteed for dollar's etc., product industry World Wide, planet earth etc., or even into the next life time and skyscraper's to one in every state within the fifty states and foreign country.
